(19) United States
(12) Patent Application Publication
(10) Pub. No.: US 2009/0104927 A1
(43) Pub. Date: Apr. 23, 2009

(54) Communication System, Communication Apparatus and Communication Control Method

(75) Inventors: Yuuya Tounai, Kawasaki-shi (JP); Masamitsu Nishikido, Yokohama-shi (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto-shi, Kyoto (JP)

(21) Appl. No.: 12/065,079

(22) PCT Filed: Aug. 29, 2006
(86) PCT No.: PCT/JP2006/316955

§ 371 Date: Feb. 27, 2008

(30) Foreign Application Priority Data
Aug. 30, 2005 (JP) 2005-248954

(51) Int. Cl. H04B 7/005

(52) U.S. Cl. 455/522

(57) ABSTRACT

A communication system that applies different modulation methods to a first data portion and a second data portion which constitute communication data, includes: a receiving strength detection unit which detects a receiving strength of the communication data; a receiving strength transmission unit transmitting the receiving strength to a transmission portion which transmits the communication data; a receiving unit which receives the transmitted receiving strength; and a transmission power control unit which controls transmission power for transmitting each of the first and second data portions based on the transmitted receiving strength. Therefore, the communication system can improve the demodulation characteristics and reduce a power consumption of a communication apparatus at a receiving side

### TECHNICAL FIELD

The present invention relates to a communication system, a communication apparatus and a communication control method which governs a transmission electric power control.

Priority is claimed on Japanese Patent Application No. 2005-248954, filed Aug. 30, 2005, the content of which is incorporated herein by reference.

### BACKGROUND ART

In recent mobile communication system, an adaptive modulation method is applied which switches modulation methods in accordance with the condition of a transmission line which changes or fluctuates with time. In the adaptive modulation method, a modulation method with a high level of reliability (low class) is used for transmitting data if the condition of the transmission line is not preferable, and a modulation method which can transmit a large volume of data (high class) is used for transmitting data if the condition of the transmission line is preferable. For example, in the adaptive modulation method, a frame of communication data is divided into a non-adaptive modulation area and an adaptive modulation area. A modulation method of π/4-shift DQPSK is fixed and applied to the non-adaptive modulation area, and one of the modulation methods, such as π/2-shift DBPSK, D8PSK, 16QAM, 32QAM or 64QAM, is used in the adaptive modulation area.

On the other hand, in a mobile communication system which provides a transmission power control, both an open-loop power control method and a closed-loop power control method are generally used. By using the closed-loop power control method, it is possible to provide a stable and preferable control even if there are differences in the transmission conditions and interference between upstream and downstream communication. However, the closed-loop power control method has problems of causing lower amount of transmission data and considerable control delay. Contrary to the closed-loop power control method, the open-loop power control method has advantages of avoiding lower amount of transmission data, less control delay, and the like. It is generally known that the control characteristics deteriorate if there are differences in transmission conditions and interference between upstream and downstream transmission. Therefore, in the mobile communication systems which are used today, both the closed-loop power control method and the open-loop power control method are used in appropriate combination in order to provide appropriate transmission power control.

Here, in reference to FIGS. 5 and 6, an operation of a communication system is explained in which both the adaptive modulation method and the transmission power control are used. FIG. 5 is a block diagram which shows the constitution of a communication apparatus (mobile station) which establishes a wireless connection with a base station and conducts a data communication to the base station not shown in the drawings. In FIG. 5, a reference numeral 4 is a transmission portion for transmitting data, and the transmission portion 4 is constituted from a transmission digital modulation portion 41, a transmission power control portion 42, a transmission RF operation portion 43 and a modulation method determination portion 44. A reference numeral 5 is an antenna for receiving and transmitting wireless signals. A reference numeral 6 is a receiving portion for receiving data and is constituted from a received RF operation portion 61 and a received BB operation portion 62.

Next, in reference to FIG. 6, an operation of the closed-loop transmission control is explained in which the mobile station shown in FIG. 5 transmits data to the base station not shown in the drawings. First, the base station receives communication data (Step S22) including communication data which has been transmitted from the transmission portion 4 of the mobile station (Step S21), and measures and calculates SNR (signal-to-noise ratio) (Step S23). After that, the SNR information including SNR obtained by measuring and calculating is transmitted by the base station to the mobile station (Step S24). The receiving portion 6 of the mobile station receives the SNR information (Step S25), and outputs the SNR information to the transmission portion 4. The modulation method determination portion 44 determines the modulation method used on the transmission data based on the SNR information output from the receiving portion 6 (Step S26). Here, if the SNR is in an allowable condition, the modulation method being used is switched to a high class modulation method. However, if the SNR is in a poor condition, the modulation method is switched to a low class modulation method.

After that, the modulation method determination portion 44 notifies the transmission digital modulation portion 41 and the transmission power control portion 42 of the determined modulation method. The transmission digital modulation portion 41 receives the notification, generates signals by modulating the communication data to be transmitted in accordance with the determined modulation method, and outputs the signals to the transmission power control portion 42. The transmission power control portion 42 controls the transmission power of the signals output from the transmission digital modulation portion 41 based on both the determined modulation method and the SNR information output from the receiving portion 6 (Step S27), and transmits the communication data (Step S21). In this operation, the transmission power is controlled so as to be minimized while maintaining communication quality, based on the minimum SNR necessary for the determined modulation method. For example, if QPSK is applied for communication, the mobile station compares the receiving SNR of the base station included in the SNR information received from the base station to the minimum SNR necessary for QPSK. Based on the comparison result, if the receiving SNR of the base station greatly exceeds the minimum SNR necessary for QPSK, the transmission power is reduced in order to prevent the transmission power from being wasted. In other words, transmission is conducted by using the lowest power which satisfies the minimum communication quality of QPSK (satisfies the minimum SNR necessary). With regard to each of the modulation methods, it should be noted that the minimum SNR necessary is SNR which is necessary for receiving the transmitted signal, and moreover, if the signal is received even though SNR is lower than the minimum SNR necessary, there are cases in which it is not possible to demodulate the signal, the error rate is very high, or the like.

A transmission power control method is generally known (for example, Patent Document 1). In the control method, when connecting a diversity terminal to the base station of a mobile communication system which has multiple terminals including the diversity terminal, in order to prevent receiving ability of the diversity terminal from deteriorating, an adaptive array base station controls the waveforms of downstream transmission power so that, regarding the diversity terminal, the transmission power is lowered when measuring the receiving level of a chip antenna, and the transmission power is increased when measuring the receiving level of a whip antenna used as a transmission antenna.

[Patent Document 1] Japanese Patent Application, First Publication No. 2003-069473

### DISCLOSURE OF INVENTION

Nowadays, a conventional communication system which applies the adaptive modulation method conducts a transmission power control which is not based on the minimum SNR (signal-to-noise ratio) necessary for the modulation methods of both the communication data of an adaptive modulation area and the communication data of the non-adaptive modulation area. The conventional communication system which applies the adaptive modulation method conducts the same transmission power control to the total frame based on the minimum SNR necessary of the adaptive modulation method. Therefore, with regard to an operation of reducing the transmission power by using a combination of modulation methods, there is a possibility of causing an error because of a UW (unique word) portion which is included in the non-adaptive modulation area and which has a large effect on demodulation characteristics. On the other hand, with regard to an operation of increasing the transmission power, transmission of non-adaptive modulation area including the UW portion is conducted by using more power than necessary. That is, the power is wasted by using more power then necessary because of a control based on the minimum SNR necessary for the modulation method of the adaptive modulation area.

The present invention was conceived in order to solve the above-described problems. With regard to a mobile communication system which uses an adaptive modulation method and conducts transmission power control, the present invention has an objective to provide a communication system, a communication apparatus and a communication control method that lower power consumption at a transmission side for transmitting a portion of the communication data as much as possible which has problematic effect on the demodulation characteristics, and that can improve the demodulation characteristics and reduce power consumption of a communication apparatus at a receiving side.

The present invention may be a communication system that applies different modulation methods to a first data portion and a second data portion which constitute communication data, is characterized by including: a receiving strength detection unit which detects a receiving strength of the communication data; a receiving strength transmission unit transmitting the receiving strength to a transmission portion which transmits the communication data; a receiving unit which receives the transmitted receiving strength; and a transmission power control unit which controls transmission power for transmitting the first data portion and the second data portion based on the transmitted receiving strength.

The present invention is preferably characterized by further including a modulation method detection unit which detects the modulation methods of both the first data portion and the second data portion, wherein the transmission power control unit controls each of transmission power of the first data portion and transmission power of the second data portion based on both the receiving strength and the modulation methods of the first data portion and the second data portion.

The present invention is preferably characterized in a point in which if the modulation method of the first data portion has a lower communication rate than the modulation method of the second data portion, the transmission power control unit controls a transmission power of the first data portion to be lower than a transmission power of the second data portion.

The present invention is preferably characterized by further including a modulation method detection unit which detects the modulation method of the first data portion, wherein if the modulation method of the first data portion has lowest communication rate among modulation methods which can be selected, the transmission power control unit controls and increases transmission power of the second data portion.

The present invention can be a communication apparatus that communicates communication data constituted from a first data portion and a second data portion to which different modulation methods are applied, characterized by including: a receiving strength receiving unit which receives a receiving strength of the communication data transmitted from a receiving side; and a transmission power control unit which controls transmission power for transmitting each of the first and second data portions based on the transmitted receiving strength.

The present invention can be a communication control method for communicating communication data constituted from a first data portion and a second data portion to which different modulation methods are applied, characterized by including: a receiving strength receiving step in which a receiving strength of the communication data transmitted from a receiving side is received; and a transmission power control step for controlling transmission power for transmitting each of the first and second data portions based on the transmitted receiving strength.

In accordance with the present invention, an advantage can be obtained in which it is possible to lower the power consumption as much as possible at a transmission side for transmitting a portion of the communication data which has problematic effects on the demodulation characteristics, and it is possible to improve the demodulation characteristics and to reduce a power consumption of a communication apparatus at a receiving side.

### BRIEF DESCRIPTION OF THE DRAWINGS

FIG. 1 is a block diagram which shows the constitution of one embodiment of the present invention.

FIG. 2 is a flowchart showing a communication between the communication apparatus (mobile station) shown in FIG. 1 and a base station.

FIG. 3 is a drawing for explaining a table constitution of a minimum SNR necessary table 21 shown in FIG. 1.

FIG. 4 is a drawing for explaining an example of a frame format of communication data.

FIG. 5 is a block diagram showing the constitution of a communication apparatus of the adaptive modulation method.

FIG. 6 is a flowchart showing communication between a communication apparatus (mobile station) as shown in FIG. 5 and a base station.

### DESCRIPTION OF THE REFERENCE SYMBOLS

1: transmission portion

11: mapper

12: transmission symbol power control portion

13: root Nyquist filter

14: filter

15: transmission power control portion

16: quadrature modulation portion

17: transmission RF operation portion

18: modulation method determination portion

19: modulation method comparing portion

20: power control value calculation portion

21: minimum SNR necessary table

2: antenna

3: receiving portion

31: received RF operation portion

32: received BB operation portion

### BEST MODE FOR CARRYING OUT THE INVENTION

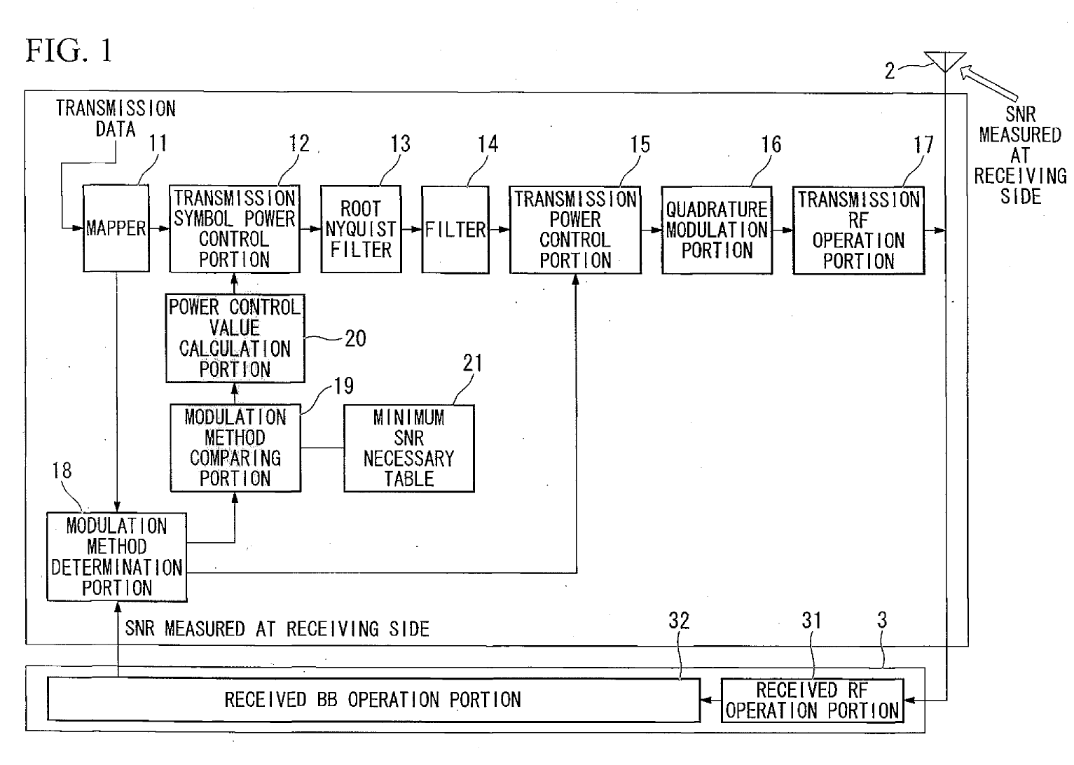

Hereinafter, a communication system of one embodiment of the present invention is explained in reference to the drawings. FIG. 1 is a block diagram showing the constitution of a communication apparatus (mobile station) of this embodiment. In this drawing, a reference numeral 1 is a transmission portion for transmitting data. A reference numeral 2 is an antenna for transmitting and receiving wireless signals. A reference numeral 3 is a receiving portion for receiving data and is constituted of a received RF operation portion 31 and a received BB operation portion 32. A reference numeral 11 is a MAPPER which divides transmission data in one burst into a number of symbols corresponding to the modulation method, and which conducts a data mapping of the symbols on a constellation. A reference numeral 12 is a transmission symbol power control portion which grasps a symbol position inside the frame format that changes with time and conducts a transmission power control of each of transmission symbol. A reference numeral 13 is a root Nyquist filter which conducts a band-limitation on the transmission signal that has been power controlled with regard to each of symbols in order to obtain a necessary IF signal frequency by conducting an up-conversion operation. A reference numeral 14 is a filter for cancelling signals other than necessary signal elements. A reference numeral 15 is a transmission power control portion which conducts a transmission power control. A reference numeral 16 is a quadrature modulation portion which conducts a quadrature modulation operation. A reference numeral 17 is a transmission RF operation portion which transmits the communication data for transmission.

A reference numeral 18 is a modulation method determination portion which selects and determines the modulation method to be applied to the adaptive modulation area based on the SNR information which is measured on a receiving side and output from the receiving portion 3. A reference numeral 19 is a modulation method comparing portion which compares the minimum SNR necessary for the modulation method applied to the adaptive modulation area as determined by the modulation method determination portion 18 to the minimum SNR necessary for the modulation method of the non-adaptive modulation area as determined by the modulation method determination portion 18. A reference numeral 20 is a power control value calculation portion which calculates the transmission power control values to be applied to the modulation methods applied to both the adaptive modulation area and the non-adaptive modulation area based on the comparison results of the modulation method comparing portion 19. A reference numeral 21 is a minimum SNR necessary table which stores the predetermined minimum SNR necessary for each of the modulation methods.

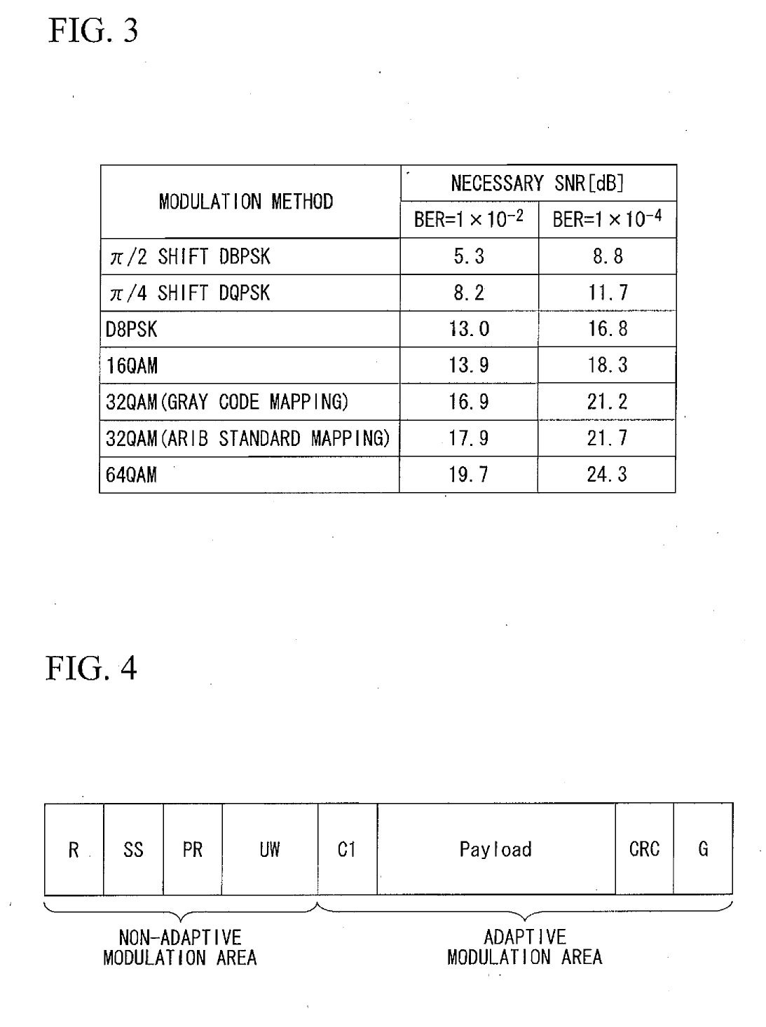

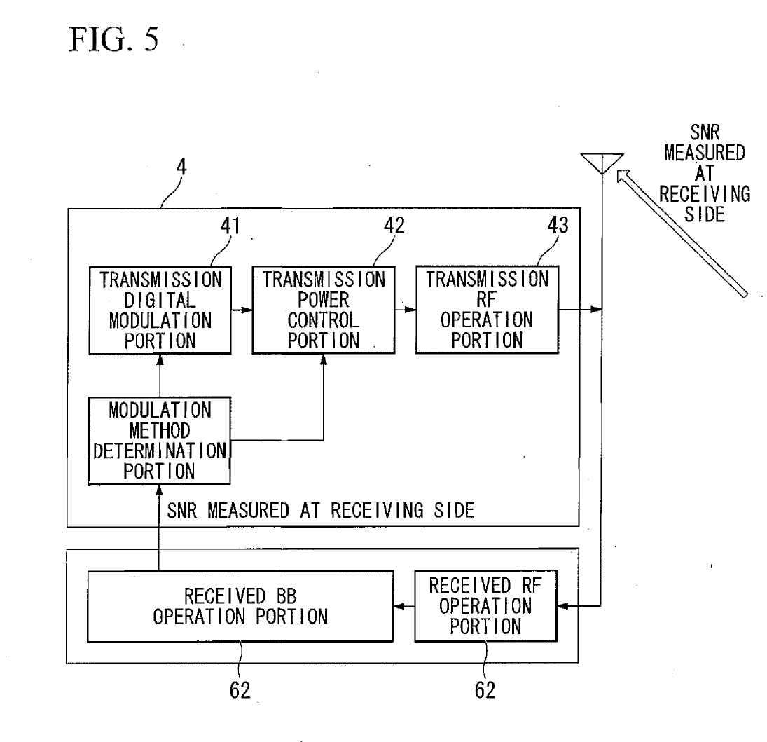

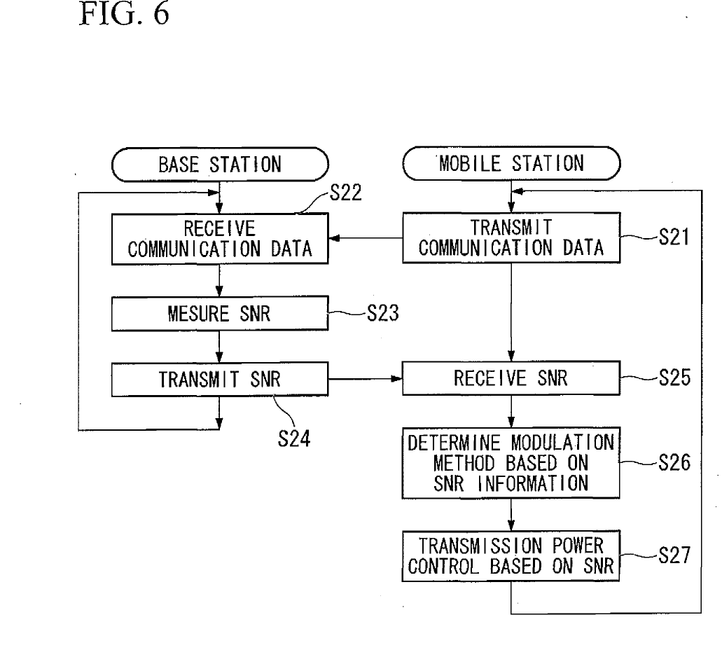

Next, in reference to FIG. 3, a table structure of the minimum SNR necessary table 21 shown in FIG. 1 is explained. The minimum SNR necessary table 21 stores the predetermined minimum SNR necessary for each of the modulation methods (π/2-shift DBPSK, π/4-shift DQPSK, D8PSK, 16QAM, 32QAM and 64QAM) which can be used inside the mobile station shown in FIG. 1. Moreover, the minimum SNR necessary table 21 also stores minimum SNR necessary with regard to each of the predetermined BER (bit error ratio). FIG. 3 shows an example in which minimum SNR necessary for each of the modulation methods with regard to a BER of 1×10⁻² and 1×10⁻⁴ is stored.

Next, in reference to FIG. 4, a frame format of the adaptive modulation method is explained. As shown in FIG. 4, the inside of the frame is divided into a non-adaptive modulation area to which a fixed modulation method is applied and an adaptive modulation area to which modulation methods are applied that are switched based on the condition of a transmission line. In such a frame constitution, the non-adaptive modulation area includes, for example, a UW (unique word) which has effects on demodulation characteristics, and the adaptive modulation area includes Payload (payload symbol) that is the data to be transmitted.

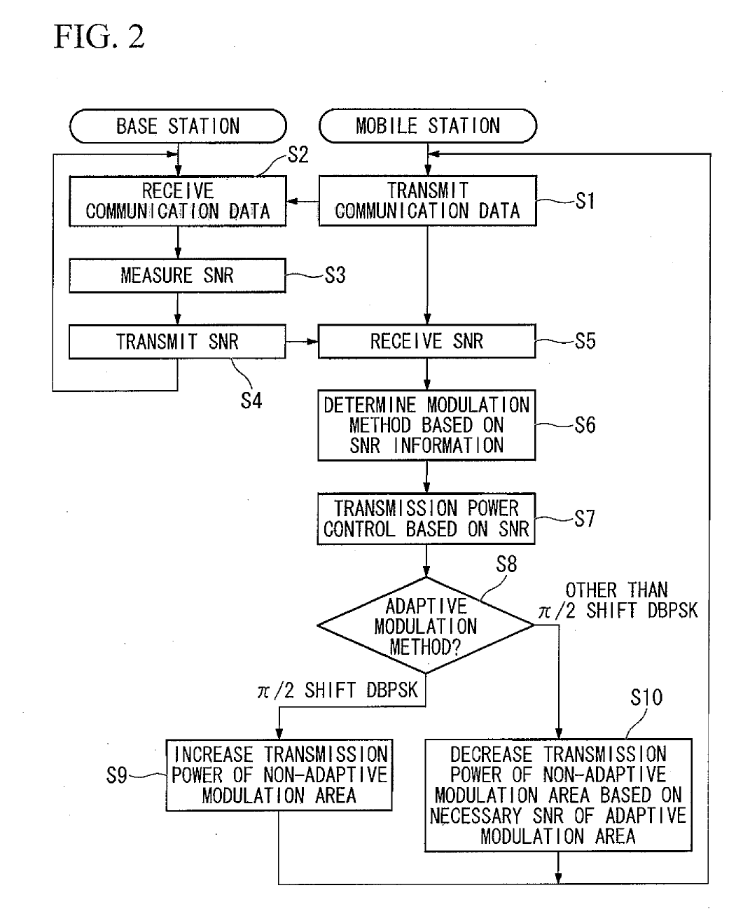

Next, in reference to FIG. 2, an operation of a closed-loop transmission power control is explained in a case of transmitting data from the communication apparatus (mobile station) shown in FIG. 1 to the base station not shown in the drawings.

First, the base station receives the communication data transmitted (Step S1) from the transmission portion 1 of the mobile station (Step S2), and measures the SNR (signal-to-noise ratio) of the received signal (Step S3). Then, the base station transmits the information including the measured and obtained SNR to the mobile station (Step S4). The receiving portion 3 of the mobile station receives the SNR information (Step S5) and outputs the SNR information to the transmission portion 1. The modulation method determination portion 18 determines the modulation method based on the SNR information output from the receiving portion 3 (Step S6). Here, if the SNR indicates an allowable condition, the modulation method determination portion 18 decides to switch the modulation method to a high class, and on the other hand, if the SNR indicates a severe condition, the modulation method determination portion 18 decides to switch the modulation method to a low class. A predetermined modulation method is applied to the non-adaptive modulation area. Here, the modulation method applied to the non-adaptive modulation area is π/4-shift DQPSK. The modulation method determination portion 44 notifies the mapper 11, transmission power control portion 15 and modulation method comparing portion 19 of the determined modulation method. The transmission power control portion 15 receives the notification and conducts a transmission power control applied to a case of transmitting symbols of the adaptive-modulation area based on the minimum SNR necessary for the determined modulation method of the adaptive modulation area (Step S7).

In addition, the modulation method comparing portion 19 determines whether or not the modulation method applied to the adaptive modulation area is π/2-shift DBPSK (Step S8). It should be noted that such a comparison is an operation applied to a case in which the modulation method of the non-adaptive modulation area is fixed to π/4-shift DQPSK. In a conventional case, the modulation method comparing portion 19 compares the minimum SNR necessary for the modulation method of the adaptive modulation area to the minimum SNR necessary for the modulation method of the non-adaptive modulation area, and determines “the minimum SNR necessary for the modulation method of the non-adaptive modulation area>the minimum SNR necessary for the modulation method of the adaptive modulation area” or “the minimum SNR necessary for the modulation method of the non-adaptive modulation area<the minimum SNR necessary for the modulation method of the adaptive modulation area”.

Based on the comparison result, if the modulation method applied to the adaptive modulation area is π/2-shift DBPSK (the minimum SNR necessary for the modulation method applied to the non-adaptive modulation area>the minimum SNR necessary for the modulation method applied to the adaptive modulation area), the modulation method comparing portion 19 outputs a command to the power control value calculation portion 20 in order to increase the transmission power of the non-adaptive modulation area (Step S9). The power control value calculation portion 20 receives the command, calculates the transmission power control value in order to increase the transmission power of the non-adaptive modulation area, and outputs the transmission power control value to the transmission symbol power control portion 12. In accordance with such operations, the transmission power applied to transmission symbols of the non-adaptive modulation area is controlled so as to be increased. It should be noted that, for example, in the case of PHS, the range of increasing the transmission power is limited to a range which is determined by transient response characteristics of RCR-STD.

On the other hand, if a modulation method other than π/2-shift DBPSK (any one of D8PSK, 16QAM, 32QAM or 64QAM) (the minimum SNR necessary for the modulation method of the non-adaptive modulation area<the minimum SNR necessary for the modulation method of the adaptive modulation area) is applied to the adaptive modulation area, the modulation method comparing portion 19 outputs a command to the power control value calculation portion 20 to reduce the transmission power applied to the non-adaptive modulation area (Step S10). The power control value calculation portion 20 receives the command, calculates the transmission power control value, and outputs the transmission power control value to the transmission symbol power control portion 12 in order to reduce the transmission power of the non-adaptive modulation area. In accordance with such operations, the transmission power applied to the transmission symbol of the non-adaptive modulation area is controlled so as to be reduced. The transmission power applied to the non-adaptive modulation area is controlled so as to satisfy the minimum SNR necessary for π/4-shift DQPSK, that is, 8.2 [dB] (in the case of BER=1×10⁻²).

It should be noted that, it is not limited to the overall non-adaptive modulation area, and it is possible to conduct a control of increasing or reducing the transmission power with regard to a control of the transmission power of only UW symbols and/or PR symbols.

As described above, in the case of conducting adaptable switching of the modulation methods and conducting the transmission power control, when the modulation method applied to the non-adaptive modulation area is π/4-shift DQPSK and the modulation method applied to the adaptive modulation area is π/2-shift DBPSK, if BER=1×10⁻², the minimum SNR necessary is 8.2 [dB] for π/4-shift DQPSK and the minimum SNR necessary is 5.2 [dB] for π/2-shift DBPSK (see FIG. 3). This means that if BER is the same, π/2-shift DBPSK can be applied in the case of lower SNR. Therefore, when the minimum SNR necessary can be small with regard to the Payload portion of the adaptive modulation area, the transmission power is controlled so as to be the same and minimized in the overall frame by the transmission power control. In such a case, the transmission power of the UW portion of the non-adaptable modulation area is reduced, and there is a possibility in which the demodulation characteristics of the communication apparatus of the receiving side deteriorate because of UW errors. If UW errors are caused, frame synchronization, frequency estimation, phase estimation, training regarding AAA, SINR estimation, and the like conducted based on UW information are not accurately conducted, and demodulation characteristics of the received data deteriorate. Therefore, it is possible to prevent the demodulation characteristics of the received data by increasing the transmission power applied to the non-adaptive modulation area (especially UW, and the like which can have effect on demodulation characteristics) with in a range as much as possible.

On the other hand, when the modulation method applied to the non-adaptive modulation area is π/4-shift DQPSK and the modulation method applied to the adaptive modulation area is 64QAM, the minimum SNR necessary is 19.7 [dB] for 64QAM. Therefore, the transmission power is increased by the transmission power control. However, π/4-shift DQPSK, which is the modulation method applied to the non-adaptive modulation area does not need such a large amount of SNR as 19.7 [dB], and 8.2 [dB] is sufficient. Therefore, more transmission power is used than necessary. Therefore, it is possible to reduce the power consumption of the communication apparatus at a transmission side by reducing the transmission power of the non-adaptive modulation area as low as possible within a range which satisfies the predetermined reception quality.

It should be noted that the mobile terminal of the present invention includes a cellular phone which can use a mobile communication function, a mobile information terminal (PDA) which has a mobile communication function, a mobile terminal, a car navigation system, and the like.

Moreover, it is also possible that a computer program for achieving the functions of the operation portion shown in FIG. 1 to be stored in a computer-readable medium where, a computer system read the computer program stored in the medium, and the transmission power control operation is conducted by executing the computer program. It should be noted that, here the “computer system” includes an OS, hardware including peripheral devices, and the like.

In addition, the “computer-readable medium” is a mobile medium such as a flexible disc, a magneto-optical disc, a ROM and a CD-ROM, and a storage device such as a hard disc. Furthermore, the “computer-readable medium” includes a storage device or a memory such as a volatile memory (RAM) inside a computer system which can be a server or a client that is used when the computer program is transmitted via a network such as the Internet or via a communication line such as a telephone line.

In addition, it is possible to transmit the above-described computer program from a computer system which stores the computer program in a storage device or the like, to another computer system via a transmission medium or via transmission waves included in the transmission medium. Here, the “transmission medium” is a medium which has a function of transmitting information, for example, a network (communication network) such as Internet and a communication network (communication line) such as a telephone line. Moreover, it is possible that the above-described computer program is constituted so as to accomplish some of the above described functions. Furthermore, it is possible that the above-described computer program be provided so as to realize the above-described functions by being linked with another computer program which is already stored in the computer system, that is, it is possible that the above-described computer program be a differential file (differential program).

### INDUSTRIAL APPLICABILITY

In accordance with the present invention, with regard to a communication system, a communication apparatus and a communication control method which conduct a transmission power control, an advantage can be obtained in which it is possible to lower a power consumption at a transmission side for transmitting a portion of communication data as much as possible which has problematic effects on the demodulation characteristics, and to improve the demodulation characteristics and to reduce a power consumption of a communication apparatus of a receiving side.

1. A communication system that applies different modulation methods to a first data portion and a second data portion which constitute communication data, comprising:
a receiving strength detection unit which detects a receiving strength of the communication data;
a receiving strength transmission unit transmitting the receiving strength to a transmission portion which transmits the communication data;
a receiving unit which receives the transmitted receiving strength; and
a transmission power control unit which controls transmission power for transmitting both the first and second data portions based on the transmitted receiving strength.

2. A communication system according to claim 1 further comprising a modulation method detection unit which detects the modulation methods of both the first data portion and the second data portion, wherein
the transmission power control unit controls both transmission power of the first data portion and the transmission power of the second data portion based on both the receiving strength and the modulation methods used to both the first data portion and the second data portion.

3. A communication system according to claim 2, wherein
if the modulation method of the first data portion has a lower communication rate than the modulation method of the second data portion, the transmission power control unit controls the transmission power of the first data portion to be lower than the transmission power of the second data portion.

4. A communication system according to claim 1 further comprising a modulation method detection unit which detects the modulation method of the first data portion, wherein
if the modulation method of the first data portion has the lowest communication rate among modulation methods which can be selected, the transmission power control unit controls and increases transmission power of the second data portion.

5. A communication apparatus that transmits and receives communication data constituted of a first data portion and a second data portion to which different modulation methods are applied, comprising:
a receiving strength receiving unit which receives a receiving strength of the communication data transmitted from a receiving side; and
a transmission power control unit which controls transmission power for transmitting each of the first and second data portions based on the receiving strength transmitted from the receiving side.

6. A communication control method for transmitting and receiving communication data constituted of a first data portion and a second data portion to which different modulation methods are applied, comprising:
a receiving strength receiving step in which a receiving strength of the communication data transmitted from a receiving side is received; and
a transmission power control step for controlling transmission power for transmitting each of the first and second data portions based on the receiving strength transmitted from the receiving side.
